(19) United States
(12) Patent Application Publication
(10) Pub. No.: US 2014/0234768 A1
(43) Pub. Date: Aug. 21, 2014

(54) TONER AND METHOD FOR PRODUCING THE SAME

(71) Applicant: TOSHIBA TEC KABUSHIKI KAISHA, Tokyo (JP)

(72) Inventors: Takafumi Hara, Shizuoka-ken (JP); Masahiro Ikuta, Shizuoka-ken (JP); Tsuyoshi Itou, Shizuoka-ken (JP); Motonari Udo, Shizuoka-ken (JP); Kazuhisa Takeda, Shizuoka-ken (JP)

(73) Assignee: TOSHIBA TEC KABUSHIKI KAISHA, Tokyo (JP)

(21) Appl. No.: 14/208,443

(22) Filed: Mar. 13, 2014

Related U.S. Application Data
(63) Continuation-in-part of application No. 13/664,704, filed on Oct. 31, 2012.
(60) Provisional application No. 61/564,087, filed on Nov. 28, 2011.

(51) Int. Cl. G03G 9/093; G03G 9/08

(52) U.S. Cl. CPC G03G 9/093; G03G 9/0819
USPC 430/109.1; 430/137.14

(57) ABSTRACT

Provided is a method for producing a toner including: aggregating colorant particles and release agent particles, thereby forming aggregates containing the colorant particles and the release agent particles; aggregating binder resin particles and the obtained aggregates containing the colorant particles and the release agent particles, thereby forming toner particle precursors; and aggregating and fusing the obtained toner particle precursors, thereby forming toner particles, wherein when the average circularity of the toner particles is represented by Rt, Rt satisfies the following formula (1): 0.85≦Rt≦0.92 (1).

### CROSS REFERENCE TO RELATED APPLICATIONS

This application is a Continuation-in-Part of Non-provisional application Ser. No. 13/664,704, filed on Oct. 31, 2012, which is based upon and claims the benefit of priority from U.S. Provisional application Ser. No. 61/564,087, filed on Nov. 28, 2011; the entire contents of both of which are incorporated herein by reference.

This application is also based upon and claims the benefit of priority from U.S. Provisional application Ser. No. 61/788,626, filed on Mar. 15, 2013; the entire contents of which are incorporated herein by reference.

### FIELD

Embodiments described herein relate generally to techniques for a toner and a method for producing the same.

### BACKGROUND

As a method for producing a toner, there is known a production method called “aggregation method”. The aggregation method is carried out according to the following procedure. First, toner components such as a binder resin, a colorant, and a release agent are aggregated using an aggregating agent such as a metal salt in a medium such as water by intentionally destroying the dispersed state of the respective particles, whereby aggregated particles are obtained. Subsequently, the obtained aggregated particles are fused by a heating treatment, whereby a toner is obtained. The fusing step and the aggregation step are sometimes performed simultaneously.

In this aggregation method, a toner is produced by, for example, aggregating particles in the nanometer order, and therefore, the particle diameter of the toner can be reduced and also the shape of the toner can be changed according to the conditions for the heating treatment for fusing the particles, and therefore, this method is very suitable as the method for producing a toner.

However, the aggregation method in the related art has a problem that, among the constituent components of the toner, a component in the form of particles having higher hydrophilicity than the binder resin or a component in the form of particles having a micron-order particle diameter is easily exposed on a toner surface.

Further, as a decolorizable colorant, there is known a colorant obtained by microencapsulation of a color developable agent including a leuco dye or the like and a color developing agent. This material can be decolorized by heating. However, when a toner is produced by an aggregation method using the microencapsulated colorant, the toner has a problem that a toner component is easily exposed on a toner surface as described above or a toner component is easily detached.

As a method for improving the above-described problem that a toner component is exposed on a toner surface, there is known a method in which a surface of a toner core particle is coated with resin particles to effect encapsulation. However, when highly hydrophilic particles having a micron-order particle diameter are used, the coating with resin particles easily proceeds while maintaining the shape of the material in the micron order, and thus, toner particles having a high circularity with a shape close to a true sphere are liable to be formed, and further, it is also necessary to increase the coating density with the resin particles.

Such a toner has a problem that when the toner is used, the cleaning property is deteriorated.

### DESCRIPTION OF THE DRAWING

FIG. 1 is a flow chart of a method for producing a toner according to an embodiment.

### DETAILED DESCRIPTION

According to this embodiment, a method for producing a toner including: forming aggregates containing colorant particles; aggregating binder resin particles and the obtained aggregates containing the colorant particles, thereby forming toner particle precursors; and aggregating and fusing the obtained toner particle precursors, thereby forming toner particles, wherein the average circularity of the toner particles is controlled so as to satisfy the following formula (1): 0.85≦Rt≦0.92 (1), wherein Rt represents the average circularity of the toner particles is provided.

Hereinafter, embodiments will be described with reference to the accompanying drawing.

According to this embodiment, a decolorizable toner composed of toner particles including a binder resin and colorant particles which contain a color developable compound, a color developing agent, and a decolorizing agent, and have a capsule structure coated with an outer shell, wherein when the average circularity of the toner particles is represented by Rt, Rt satisfies the above formula (1) is provided.

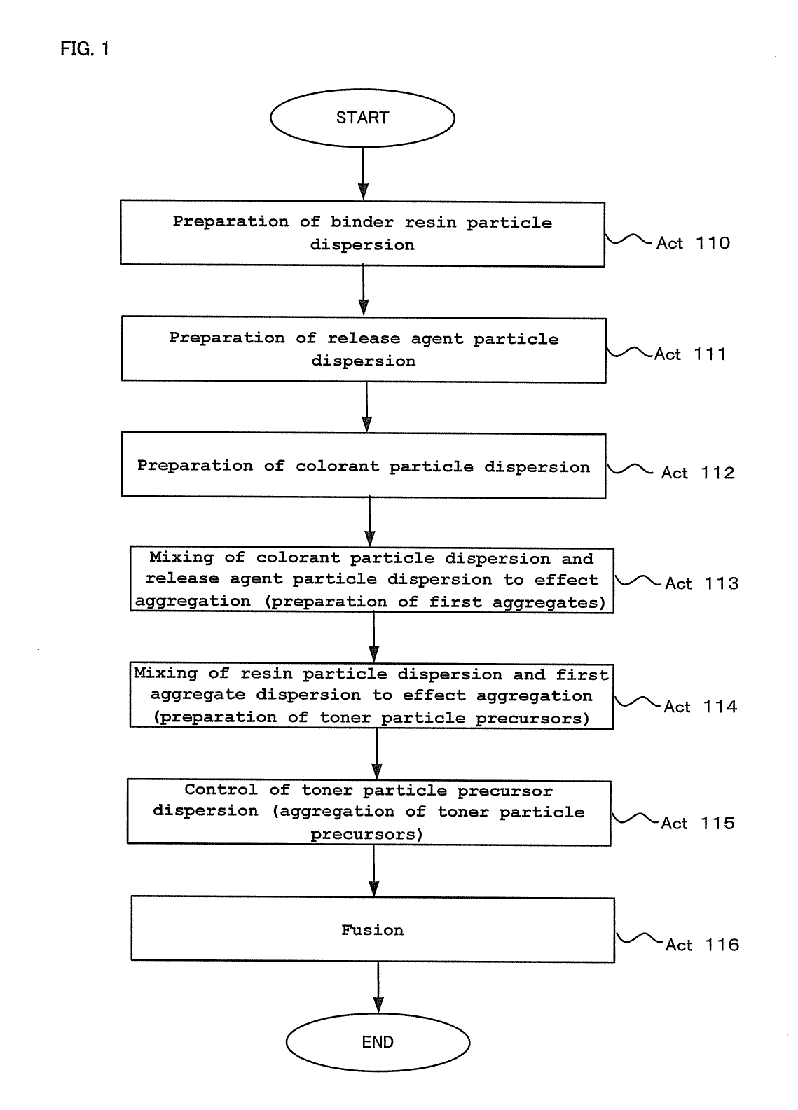

First, one example of the method for producing a toner of this embodiment will be described with reference to the flow chart shown in FIG. 1. Hereinafter, a case where a release agent to be contained as needed is used will be described as an example.

First, in Act 110, Act 111, and Act 112, a binder resin particle dispersion, a release agent particle dispersion, and a colorant particle dispersion are prepared. Incidentally, the “colorant” as used herein refers to one type of compound or a composition, which imparts a color to the toner.

A method for preparing the respective particle dispersions is not particularly limited and can be appropriately selected by those skilled in the art. Examples thereof may include an emulsion polymerization method, a mechanical emulsification method, a phase inversion emulsification method, and a melting emulsification method. Further, the surface of each particle produced may be encapsulated by an interface polymerization method, an in situ polymerization method, a coacervation method, an in-liquid drying method, an in-liquid curing coating method, or the like. As a dispersion medium to be used in the preparation of the dispersion, for example, water, an alcohol such as ethanol or glycerin, a water-soluble organic solvent such as glycol ether, or the like can be used.

In this embodiment, the volume average particle diameter of the release agent particles is preferably smaller than that of the colorant particles, and the volume average particle diameter of the binder resin particles is preferably smaller than that of the release agent particles.

The volume average particle diameter of the colorant particles in the colorant particle dispersion is preferably 0.5 μm or more from the viewpoint of charge stability and storage stability of the toner, and 7 μm or less from the viewpoint of color developability of the toner. The volume average particle diameter of the colorant particles is more preferably from 0.7 μm to 5 μm.

Further, from the viewpoint of charge stability and storage stability of the toner, the volume average particle diameter of the binder resin particles in the binder resin particle dispersion is preferably from 0.01 μm to 1.0 μm.

The “volume average particle diameter” as used herein refers to a particle diameter of a particle in the dispersion which is measured as a volume median diameter (D50) by a laser diffraction scattering method. In this embodiment, the volume average particle diameter can be measured using, for example, SALD-7000 manufactured by Shimadzu Corporation or Coulter Counter Multisizer III (Beckman Coulter Inc.).

In this embodiment, as an example, as shown in FIG. 1, the binder resin particle dispersion, the release agent particle dispersion, and the colorant particle dispersion are prepared in Act 110, Act 111, and Act 112, however, the order or the like of the preparation of these dispersions is not particularly limited as long as the preparation is completed before being subjected to mixing or the like.

Subsequently, in Act 113, the colorant particle dispersion and the release agent particle dispersion are mixed, and the colorant particles and the release agent particles are aggregated, thereby forming aggregates containing the colorant particles and the release agent particles (hereinafter referred to as “first aggregates”).

A method for forming the first aggregates obtained in Act 113 is not particularly limited, and for example, an aggregation method with the use of a metal salt or by the adjustment of pH, or a method in which the colorant particles and the release agent particles are prepared so as to have zeta potentials of opposite sign, and then mixed with one another to aggregate the colorant particles and the release agent particles can be used. In the first aggregates, the release agent particles having a volume average particle diameter smaller than that of the colorant particles are disposed outside the colorant particles.

In Act 114, the binder resin particle dispersion and the first aggregate dispersion are mixed by stirring, and the first aggregates and the binder resin particles are aggregated in the obtained dispersion of the first aggregates and the binder resin particles, whereby toner particle precursors, which are aggregates of the first aggregates and the binder resin particles are formed.

The binder resin particles have a volume average particle diameter smaller than that of the release agent particles which are disposed outside the colorant particles in the toner particle precursors. As a result, the binder resin particles are disposed outside the release agent particles. Therefore, the surfaces of the first aggregates are coated with the binder resin particles.

A method for aggregating the first aggregates and the binder resin particles is not particularly limited, and for example, a hetero-aggregation method or the like can be used.

Subsequently, in Act 115, the toner particle precursors are aggregated in the dispersion containing the toner particle precursors.

The aggregation of the toner particle precursors can be achieved by, for example, the control of the dispersed state of the toner particle precursors. Specifically, the control of the dispersed state of the toner particle precursors can be performed by at least any of the following methods: a method of decreasing the stirring speed of the dispersion containing the toner particle precursors as compared with the case where the toner particle precursors are formed; a method of increasing the temperature of the dispersion containing the toner particle precursors as compared with the case where the toner particle precursors are formed; and a method of adding an aggregating agent to the dispersion containing the toner particle precursors. Incidentally, a specific stirring speed, a specific temperature, a specific addition amount of the aggregating agent, etc. can be appropriately determined by those skilled in the art.

Further, in Act 116, a surfactant is added to a dispersion of the aggregates of the toner particle precursors as needed, and a fusing treatment by heating is performed, whereby toner particles are formed.

The fusing temperature is not particularly limited and can be appropriately determined by those skilled in the art, but generally set to a temperature equal to or higher than the glass transition temperature Tg of the binder resin. Therefore, when the colorant contains a color developable compound and a color developing agent, and the decolorizing temperature at which the colorant is decolorized is lower than the fusing temperature, the color is erased in the fusing step. Accordingly, it is preferred to design the colorant such that the decolorizing temperature of the colorant is higher than the fusing temperature.

The thus obtained toner particles have a release agent layer which is derived from the release agent particles and is disposed outside the colorant, and a binder resin layer which is derived from the binder resin particles and is disposed outside the release agent layer. That is, in the toner of this embodiment, the colorant is coated with the release agent layer and the binder resin layer disposed outside the release agent layer.

Incidentally, in the step of forming the first aggregates in Act 113, the first aggregates may contain other components such as the binder resin particles in addition to the colorant particles and the release agent particles. Specifically, the first aggregates may contain the binder resin in an amount of 15% or less with respect to the total amount of the resin to be contained in the toner particles. If the amount of the binder resin contained in the first aggregates exceeds 15% with respect to the total amount of the resin to be contained in the toner particles, the aggregation of the colorant particles and the release agent particles is lowered, and the coating with the binder resin particles in Act 114 tends to be insufficient as compared with the case where the amount of the binder resin contained in the first aggregates is set to 15% or less with respect to the total amount of the resin to be contained in the toner particles.

The thus obtained toner is, for example, filled in a toner cartridge, which is mounted on an image forming apparatus such as an MFP (multifunctional peripheral), and is used in the formation of an image. Further, when the toner is used in a dry-type electrophotographic apparatus, the toner is mounted on, for example, an electrophotographic apparatus as a non-magnetic one-component developer or two-component developer, and can be used in the formation of an image on a recording medium. When the toner is used in a two-component developer, a carrier which can be used is not particularly limited and can be appropriately selected by those skilled in the art. When the toner is used in a wet-type electrophotographic apparatus, the toner is mounted on an image forming apparatus as a dispersion in which the toner is dispersed in a carrier liquid, and can be used in the formation of an image on a recording medium in the same manner as in the dry-type electrophotographic apparatus.

In an image formation process, a toner image formed using the toner of this embodiment transferred onto a recording medium is heated at a fixing temperature, and the binder resin is melted to penetrate in the recording medium. Then, the binder resin is solidified, whereby an image is formed on the recording medium (fixing treatment).

Further, when the colorant contains a color developable compound and a color developing agent, a decolorizable toner can be obtained by the production method of this embodiment. By using the decolorizable toner, an image formed on a recording medium can be erased by performing a decolorizing treatment of the toner. Specifically, the decolorizing treatment can be performed as follows. The recording medium having an image formed thereon is heated at a heating temperature equal to or higher than the decolorizing temperature, whereby the color developable compound and the color developing agent coupled with each other can be decoupled from each other.

Here, in the production method described above, the average circularity (Rt) of the toner particles is controlled so as to satisfy the above-described formula (1).

The toner particles which satisfy the formula (1) have a shape which is not close to a true sphere and have a circularity which is not too high, and therefore have an excellent cleaning property. In addition, since the colorant particles are sufficiently coated with the binder resin, the toner particles have excellent charge stability.

On the other hand, if Rt which is the average circularity of the toner, particles is less than 0.85, the toner particles are easily ruptured, and therefore, the charge stability is deteriorated. Meanwhile, if Rt exceeds 0.92, a sufficient cleaning property cannot be ensured.

The deterioration of the cleaning property or the deterioration of chargeability is particularly prominent when the toner particles are used in an apparatus having a recycling mechanism such as a monochromatic machine, and strongly affects the occurrence of fogging, toner scattering, filming, etc.

In order for the toner particles to have an average circularity (Rt) satisfying the formula (1), for example, the volume average particle diameter of the toner particles obtained by aggregating and fusing the toner particle precursors and the volume average particle diameter of the toner particle precursors are controlled.

Here, when the volume average particle diameter of the toner particles obtained by aggregating and fusing the toner particle precursors is represented by Dt (μm), and the volume average particle diameter of the toner particle precursors is represented by Dc (μm), it is preferred to control the volume average particle diameter of the toner particles and the volume average particle diameter of the toner particle precursors so that Dt and Dc satisfy the following formula (2): 1.2≦Dt/Dc≦2 (2).

When Dt and Dc satisfy the formula (2), the shape of the toner particles is not a true sphere, and therefore, a more sufficient cleaning property can be ensured, and further, the toner particles can be more reliably prevented from rupturing due to stress or the like in the developing device or the like, and thus, charge stability can be more reliably maintained.

The case where Dt and Dc satisfy the formula (2) will be described by showing a more specific example.

For example, when the binder resin particles have a volume average particle diameter of about 0.1 to 0.5 μm, and the colorant particles have a volume average particle diameter of about 1 to 3 μm, the volume average particle diameter (Dc) of the toner particle precursors can be set to, for example, 6.5 to 7.5 μm. When Dc is 6.5 μm or more, the first aggregates containing the colorant particles can be sufficiently coated with the binder resin, and the chargeability tends to be more stabilized as compared with the case where Dc is less than 6.5 μm. Further, when Dc is 7.5 μm or less, the coating density of the first aggregates with the binder resin is not too high as compared with the case where Dc is more than 7.5 μm, and the shape of the toner particle precursors is not close to a true sphere, and therefore, there is a tendency that low-temperature fixability and a cleaning property can be sufficiently ensured.

When the volume average particle diameter (Dc) of the toner particle precursors is in the range of, for example, 6.5 to 7.5 μm, Dt which is the volume average particle diameter of the toner particles can be set to, for example, 9.5 to 12.5 μm. When Dt is 9.5 μm or more, Dt/Dc is 1.2 or more, and the shape of the toner particles is not a true sphere, and therefore, there is a tendency that a sufficient cleaning property can be ensured. Further, when Dt is 12.5 μm or less, Dt/Dc is 2 or less, and the shape of the toner particles is not a true sphere, and therefore, there is a tendency that a cleaning property can be ensured.

The materials which can be used in this embodiment are as follows.

### Binder Resin

A resin which can be used as the binder is not particularly limited, however, a polyester resin is preferred. The polyester resin has a glass transition temperature lower than a styrene resin, and a fixing treatment can be performed at a lower temperature.

Examples of an acid component to be contained in the polyester resin include aromatic dicarboxylic acids such as terephthalic acid, phthalic acid, and isophthalic acid; and aliphatic carboxylic acids such as fumaric acid, maleic acid, succinic acid, adipic acid, sebacic acid, glutaric acid, pimelic acid, oxalic acid, malonic acid, citraconic acid, and itaconic acid.

Examples of an alcohol component to be contained in the polyester resin include aliphatic diols such as ethylene glycol, propylene glycol, 1,4-butanediol, 1,3-butanediol, 1,5-pentanediol, 1,6-hexanediol, neopentyl glycol, trimethylene glycol, trimethylolpropane, and pentaerythritol; alicyclic diols such as 1,4-cyclohexanediol and 1,4-cyclohexanedimethanol; and ethylene oxide adducts of bisphenol A or propylene oxide adducts of bisphenol A.

Further, the above-described polyester components can be converted so as to have a crosslinking structure using a trivalent or higher polyvalent carboxylic acid component or a trihydric or higher polyhydric alcohol component such as 1,2,4-benzenetricarboxylic acid (trimellitic acid) or glycerin.

It is also possible to use a mixture of two or more types of polyester resins having different compositions as the binder resin.

As the polyester resin, either a crystalline polyester resin or an amorphous polyester resin can be used.

The glass transition temperature of the polyester resin is preferably 40° C. or higher and 70° C. or lower, more preferably 45° C. or higher and 65° C. or lower from the viewpoint of storage stability and low-temperature fixability of the toner.

In this embodiment, when the volume average particle diameter of the resin particles is 0.01 μm or more, the viscosity of the dispersion containing the resin particles and the first aggregates is stabilized, and thus, the production of the aggregates tends to be facilitated. Further, when the volume average particle diameter of the resin particles is 1.0 μm or less, the number of the resin particles in the dispersion is increased, and thus, the aggregates can be sufficiently coated therewith to stabilize the chargeability of the toner.

Further, the amount of the binder resin to be contained in the toner is preferably from 60 to 80% by mass, more preferably from 60 to 70% by mass with respect to the total amount of the toner components.

When the amount of the binder resin is 60% by mass or more with respect to the total amount of the toner components, the colorant particles can be incorporated in the toner, and therefore, the charge stability is stabilized. Further, when the amount of the binder resin is 80% by mass or less, a small amount of heat is sufficient for melting the binder resin when fixing the toner, and therefore, low-temperature fixability can be achieved. In the case of a decolorizable toner, if a difference between the decolorizing temperature of the toner and the fixing temperature of the toner is small, control for fixing the toner in a colored state is not easy due to this. Therefore, the low-temperature fixability is important for facilitating the control for fixing the toner in a colored state. Incidentally, the “total amount of the toner components” as used herein refers to the total amount of the components to be contained in the toner particles, and refers to a concept that additives and the like are excluded.

### Colorant

In this embodiment, for example, as the colorant particles, particles obtained by coating a composition containing at least a color developable compound, a color developing agent, and a decolorizing agent, which is contained as needed, with an outer shell can be used. A toner containing a color developable compound and a color developing agent as a colorant can be decolorized by, for example, a decolorizing treatment such as heating. That is, when a color developable compound and a color developing agent are used as a colorant, the toner of this embodiment can be used as a decolorizable toner.

The encapsulated colorant particles can be prepared by, for example, emulsifying and dispersing components to be included in the encapsulated colorant particles such as a color developable compound, a color developing agent, and a decolorizing agent, and an encapsulating agent, and then, adding a reaction agent to cause a reaction.

The encapsulating agent (a shell material) for forming an outer shell of the colorant is not particularly limited, and can be appropriately selected by those skilled in the art, and examples thereof include an aromatic polyvalent isocyanate prepolymer.

Examples of the components to be included in the encapsulated colorant particles include a material susceptible to the effect of the additive of the toner and a material which is not desired to be let out of the toner during the production. Examples of such a material include a color developable compound which can be reversibly colored and decolorized by a reaction with a color developing agent and is typified by a leuco dye, a color developing agent, and a decolorizing agent which controls this coloration and decolorization function by the reaction between the color developing agent and the color developable compound. By including these materials in a capsule, the coloration and decolorization reaction is hardly inhibited by the other components to be contained in the toner. In addition, according to this configuration, since the coloration and decolorization reaction occurs inside the capsule, the decolorization process by heating promptly proceeds, and thus, decolorization can be promptly carried out.

The color developable compound is an electron donating compound which accepts a proton from the color developing agent when coupled therewith. In this embodiment, the color developable compound is not particularly limited and can be appropriately selected by those skilled in the art, however, for example, a leuco dye can be used. Examples of the leuco dye include diphenylmethane phthalides, phenylindolyl phthalides, indolyl phthalides, diphenylmethane azaphthalides, phenylindolyl azaphthalides, fluorans, styrynoquinolines, and diaza-rhodamine lactones.

Specific examples thereof include 3,3-bis(p-dimethylaminophenyl)-6-dimethylaminophthalide, 3-(4-diethylaminophenyl)-3-(1-ethyl-2-methylindol-3-yl)phthalide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylindol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline, spiro[5H-(1)benzopyrano(2,3-d)pyrimidine-5,1′(3′H)isobenzofuran]-3′-one, 2-(diethylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)-4-methyl-, spiro[5H-(1)benzopyrano(2,3-d)pyrimidine-5,1′(3′H)isobenzofuran]-3′-one, 2-(di-n-butylamino)-8-(diethylamino)-4-methyl-, spiro[5H-(1)benzopyrano(2,3-d)pyrimidine-5,1′(3′H)isobenzofuran]-3′-one, 2-(di-n-butylamino)-8-(N-ethyl-N-1-amylamino)-4-methyl-, spiro[5H-(1)benzopyrano(2,3-d)pyrimidine-5,1′(3′H)isobenzofuran]-3′-one, 2-(di-n-butylamino)-8-(di-n-butylamino)4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. In addition, examples thereof include pyridine compounds, quinazoline compounds, and bisquinazoline compounds. These compounds may be used by mixing two or more types thereof.

The color developing agent is an electron accepting compound which donates a proton to the color developable compound such as a leuco dye. Examples of the color developing agent include phenols, metal salts of phenols, metal salts of carboxylic acids, aromatic carboxylic acids, aliphatic carboxylic acids having 2 to 5 carbon atoms, benzophenones, sulfonic acids, sulfonates, phosphoric acids, metal salts of phosphoric acids, acidic phosphoric acid esters, metal salts of acidic phosphoric acid esters, phosphorous acids, metal salts of phosphorous acids, monophenols, polyphenols, 1,2,3-triazole, and derivatives thereof. Additional examples thereof include those having, as a substituent, an alkyl group, an aryl group, an acyl group, an alkoxycarbonyl group, a carboxy group or an ester thereof, an amide group, a halogen group, or the like, and bisphenols, trisphenols, phenol-aldehyde condensed resins, and metal salts thereof. These compounds may be used by mixing two or more types thereof.

Specific examples of the color developing agent include phenol, o-cresol, tertiary butyl catechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate, dihydroxybenzoic acid and esters thereof (such as 2,3-dihydroxybenzoic acid and methyl 3,5-dihydroxybenzoate), resorcinol, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl)sulfide, 1-phenyl-1,1-bis(4-hydroxyphenyl)ethane, 1,1-bis(4-hydroxyphenyl)-3-methylbutane, 1,1-bis(4-hydroxyphenyl)-2-methylpropane, 1,1-bis(4-hydroxyphenyl)n-hexane, 1,1-bis(4-hydroxyphenyl)n-heptane, 1,1-bis(4-hydroxyphenyl)n-octane, 1,1-bis(4-hydroxyphenyl)n-nonane, 1,1-bis(4-hydroxyphenyl)n-decane, 1,1-bis(4-hydroxyphenyl)n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)n-heptane, 2,2-bis(4-hydroxyphenyl)n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzenetriol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol. These compounds may be used by mixing two or more types thereof.

Further, in this embodiment, a decolorizing agent may be contained in the colorant particles along with the color developable compound and the color developing agent.

In a three-component system including a leuco dye (a color developable compound), a color developing agent, and a decolorizing agent, the decolorizing agent is a material which inhibits the coloration reaction between the leuco dye and the color developing agent by heat, and in this embodiment, a known material can be used. As the decolorizing agent, particularly, a material which can form a coloration and decolorization mechanism utilizing the temperature hysteresis of a decolorizing agent disclosed in JP-A-60-264285, JP-A-2005-1369, or JP-A-2008-280523 has an excellent instantaneous erasing property. When a mixture of such a three-component system in a colored state is heated to a specific decolorizing temperature Th or higher, the mixture can be decolorized. Even if the decolorized mixture is cooled to a temperature equal to or lower than Th, the decolorized state is maintained. When the temperature of the mixture is further decreased, the coloration reaction between the leuco dye and the color developing agent is restored at a specific color restoring temperature Tc or lower, and the mixture returns to a colored state. In this manner, it is possible to cause a reversible coloration and decolorization reaction. In particular, it is preferred that the decolorizing agent satisfies the following relationship: Th>Tr>Tc, wherein Tr represents room temperature. Examples of the decolorizing agent capable of causing this temperature hysteresis include alcohols, esters, ketones, ethers, and acid amides. Particularly, esters are preferred. Specific examples thereof include esters of carboxylic acids containing a substituted aromatic ring, esters of carboxylic acids containing an unsubstituted aromatic ring with aliphatic alcohols, esters of carboxylic acids containing a cyclohexyl group in a molecule, esters of fatty acids with unsubstituted aromatic alcohols or phenols, esters of fatty acids with branched aliphatic alcohols, esters of dicarboxylic acids with aromatic alcohols or branched aliphatic alcohols, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These compounds may be used by mixing two or more types thereof. It is preferred to use such a decolorizing agent in an amount of 1 to 500 parts by mass, particularly 4 to 99 parts by mass with respect to 1 part by mass of the leuco dye. The toner of this embodiment can be decolorized by heating even when the decolorizing agent is not contained, however, by incorporating the decolorizing agent, the decolorizing treatment can be more promptly carried out.

Further, as the colorant, a colorant containing, in addition to the above-mentioned components, a carbon black, an organic or inorganic pigment or dye, or the like as needed may be used.

As such a pigment or a dye, for example, examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185; and C.I. Vat Yellow 1, 3, and 20. These can be used alone or in admixture. Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238; C.I. Pigment Violet 19; and C.I. Vat Red 1, 2, 10, 13, 15, 23, 29, and 35. These can be used alone or in admixture. Examples of a cyan pigment include C.I. Pigment Blue 2, 3, 15, 16, and 17; C.I. Vat Blue 6, and C.I. Acid Blue 45. These can be used alone or in admixture.

Further, the encapsulated colorant may include another component such as a resin in addition to the color developable compound, the color developing agent, and the decolorizing agent.

The amount of the colorant to be contained in the toner is preferably 10% by mass or more, more preferably 15% by mass or more with respect to the total amount of the toner components.

### Release Agent

In this embodiment, release agent particles can be used as needed. Examples of the release agent to be contained in the release agent particles include aliphatic hydrocarbon waxes such as low-molecular weight polyethylenes, low-molecular weight polypropylenes, polyolefin copolymers, polyolefin waxes, paraffin waxes, and Fischer-Tropsch wax and modified substances thereof; vegetable waxes such as candelilla wax, carnauba wax, Japan wax, jojoba wax, and rice wax; animal waxes such as bees wax, lanolin, and spermaceti wax; mineral waxes such as montan waxes, ozokerite, and ceresin; fatty acid amides such as linoleic acid amide, oleic acid amide, and lauric acid amide; functional synthetic waxes; and silicone-based waxes. When a polyester resin is used as the binder resin, from the viewpoint of low-temperature fixability and immiscibility, an aliphatic hydrocarbon wax such as a paraffin wax is preferred. When the release agent is contained in the toner, the amount thereof is not particularly limited, but is preferably 10% by mass or more with respect to the total amount of the toner components.

### Charge Control Agent

In this embodiment, another component such as a charge control agent may be contained so as to make the amount 100. As the charge control agent, a metal-containing azo compound is used, and a complex or a complex salt, in which the metal element is iron, cobalt, or chromium, or a mixture thereof is preferred. A metal-containing salicylic acid derivative compound is also used, and a complex or a complex salt, in which the metal element is zirconium, zinc, chromium, or boron, or a mixture thereof is preferred.

A method for adding such a charge control agent to the toner is not particularly limited, but for example, the charge control agent can be added to the toner by being mixed with the binder resin particles in the dispersion when the binder resin particle dispersion is prepared.

### Aggregating Agent

An aggregating agent which can be used in this embodiment is not particularly limited, and a monovalent metal salt such as sodium chloride, a polyvalent metal salt such as magnesium sulfate or aluminum sulfate, a non-metal salt such as ammonium chloride or ammonium sulfate, an acid such as hydrochloric acid or nitric acid, or a strong cationic coagulant such as polyamine or polyDADMAC can be appropriately used.

### Surfactant

In this embodiment, a surfactant can be used as needed. The surfactant is not particularly limited, and for example, an anionic surfactant such as a sulfate ester salt-based, sulfonate salt-based, phosphate ester-based, or fatty acid salt-based surfactant, a cationic surfactant such as an amine salt-based or quaternary ammonium salt-based surfactant, an amphoteric surfactant such as a betaine-based surfactant, a nonionic surfactant such as a polyethylene glycol-based, alkylphenol ethylene oxide adduct-based, or polyhydric alcohol-based surfactant, or a polymeric surfactant such as polycarboxylic acid can be appropriately used. In general, such a surfactant is added for the purpose of imparting dispersion stability such as stability of aggregated particles, however, a surfactant of opposite polarity or the like may be used as an aggregating agent.

### pH Adjusting Agent

In this embodiment, a pH adjusting agent for controlling the pH in the system can be used as needed. The pH adjusting agent is not particularly limited, and for example, a basic compound such as sodium hydroxide, potassium hydroxide, or an amine compound can be appropriately used as an alkali, and an acidic compound such as hydrochloric acid, nitric acid, or sulfuric acid can be appropriately used as an acid.

Hereinafter, the embodiment will be more specifically described by showing Examples, however, the invention is not limited to the Examples.

### Example 1

### Preparation of Binder Resin Particle Dispersion

A dispersion obtained by mixing 30 parts by mass of a polyester resin (acid value: 10 MgKOH/g, Mw: 15000, Tg: 58° C.), 1 part by mass of sodium dodecylbenzene sulfonate (Neopelex G-15, manufactured by Kao Corporation) and 69 parts by mass of ion exchanged water and adjusting the pH to 12 with potassium hydroxide was placed in a high-pressure homogenizer NANO 3000 (manufactured by Beryu Co., Ltd.), and processed at 180° C. and 150 MPa, whereby a binder resin particle dispersion was obtained. The volume average particle diameter of the thus obtained dispersion was measured using SALD-7000 manufactured by Shimadzu Corporation, and it was found that the dispersion had a volume average particle diameter of 0.1 μm and a sharp particle size distribution with a standard deviation of 0.15.

### Preparation of Colorant Particle Dispersion

Components including 2 parts by mass of 3-(4-diethylamino-2-hexyloxyphenyl)-3-(1-ethyl-2-methylindol-3-yl)-4-azaphthalide as a leuco dye, 4 parts by mass of 1,1-bis(4′-hydroxyphenyl)hexafluoropropane and 4 parts by mass of 1,1-bis(4′-hydroxyphenyl)-n-decane as color developing agents, and 50 parts by mass of 4-benzyloxyphenylethyl caprylate as a decolorizing agent were uniformly dissolved by heating. To the obtained mixture, 30 parts by mass of an aromatic polyvalent isocyanate prepolymer and 40 parts by mass of ethyl acetate were mixed therein as encapsulating agents. The obtained solution was emulsified and dispersed in 300 parts by mass of an aqueous solution of 8% polyvinyl alcohol, and the resulting dispersion was kept stirred at 70° C. for about 1 hour. Thereafter, 2.5 parts by mass of a water-soluble aliphatic modified amine was added thereto as a reaction agent, and stirring was further continued for an additional 6 hours, whereby colorless capsule particles were obtained. Then, the resulting capsule particle dispersion was placed in a freezer (−30° C.) to develop a color, and ion exchanged water was added thereto, whereby a capsule particle dispersion containing 27 wt % of the colorant effective components (solid content concentration) was obtained. The obtained particle dispersion was measured using SALD-7000 manufactured by Shimadzu Corporation and found to have a volume average particle diameter of 2.5 μm.

### Preparation of Release Agent Particle Dispersion

A dispersion obtained by mixing 40 parts by mass of carnauba wax, 1 part by mass of dipotassium alkenyl sulfosuccinate (LATEMUL ASK, manufactured by Kao Corporation), and 59 parts by mass of ion exchanged water was placed in a rotor-stator homogenizer CLEAR MIX 2.2S (manufactured by M Technique Co., Ltd.), and the temperature of the dispersion was increased to 100° C. while stirring at 1000 rpm, whereby a release agent particle dispersion was obtained. The volume average particle diameter of the obtained dispersion was measured using SALD-7000 manufactured by Shimadzu Corporation and found to be 0.5 μm.

### Preparation of Toner Particle Precursors

42 Parts by mass of the colorant particle dispersion and 63 parts by mass of ion exchanged water were mixed, and 25 parts by mass of a 30% ammonium sulfate solution was added thereto while stirring, and the resulting mixture was maintained as such for 1 hour. Thereafter, 14 parts by mass of the release agent particle dispersion was added thereto, and the temperature of the mixture was increased to 30° C. Then, 300 parts by mass of the binder resin particle dispersion in which the solid content concentration was adjusted to 15% was gradually added thereto over 10 hours, whereby toner particle precursors having a volume average particle diameter of 6.5 μm (Cv value: 16.5) were obtained.

### Preparation of Toner Particles

By increasing the temperature of the dispersion containing the toner particle precursors to 60° C. and maintaining the temperature, and also adjusting the rotation speed of the stirring device, the toner particle precursors were aggregated, whereby a dispersion of aggregates of the toner particle precursors having a volume average particle diameter of 11 μm (Cv value: 18.9) was obtained. Further, as a surfactant, 5 parts by mass of a polycarboxylic acid-based surfactant (POISE 520, manufactured by Kao Corporation) was added to the dispersion of aggregates of the toner particle precursors, and then, the resulting mixture was heated to 65° C. and left as such, whereby a fusing treatment was performed for the aggregates of the toner particle precursors, and thus, the toner particles were obtained. The obtained toner particles were washed by alternately repeating filtration and washing with ion exchanged water until the electrical conductivity of the filtrate was decreased to 50 μS/cm. Thereafter, the toner particles were dried using a vacuum dryer until the water content therein was decreased to 1.0% by mass or less, whereby a toner of Example 1 was obtained. The volume average particle diameter of the thus obtained toner particles was 11.2 μm (Cv value: 18.7). Dt/Dc was 1.72, and the average circularity of the toner particles was 0.908. Further, the surface state of the obtained toner was observed using an electron microscope, and it was found that the toner had a favorable surface property.

The composition of the toner particles of Example 1 described above was as follows: the colorant: 18.3%, the release agent: 9%, and the binder resin: 72.7%, and the amount of the binder resin was in the range of 60 to 80% by mass with respect to the total amount of the toner components. With respect to the toners of the other Examples and Comparative Examples described below, the composition of the toner particles was the same as that of Example 1.

It is because the amounts of the binder resin and the colorant are determined at the stage when the toner particle precursors are produced, and therefore, even if the toner particle precursors are aggregated and fused thereafter, the composition of the toner particles is not so much affected.

In this Example, in the measurement of the volume average particle diameters of the toner particle precursors and the toner particles, as a coulter counter, Coulter Counter Multisizer III (Beckman Coulter Inc.) was used. Further, in the measurement of the average circularity of the toner particles, FPIA-2100 (Sysmex Corporation) was used as a circularity measuring device.

The volume average particle diameter and the average circularity of the toner particles were measured before performing the treatments of filtration, washing, drying, etc.

Incidentally, the volume average particle diameter and the average circularity of the toner particles do not change before and after the treatments of filtration, washing, drying, etc.

### Comparative Example 1

Toner particles having a volume average particle diameter of 6.6 μm (Cv value: 16.7) were obtained in the same manner as in Example 1 except that after preparing the dispersion of the toner particle precursors having a volume average particle diameter of 6.5 μm (Cv value: 16.5), the fusing treatment was performed without aggregating the toner particle precursors. Dt/Dc was 1.02, and the average circularity of the toner particles was 0.964. Further, the thus obtained toner had a favorable surface state, but the shape of the toner particles was substantially a true sphere.

### Comparative Example 2

Toner particles having a volume average particle diameter of 7.7 μm (Cv value: 17.5) were obtained in the same manner as in Example 1 except that after preparing the dispersion of the toner particle precursors having a volume average particle diameter of 6.5 μm (Cv value: 16.5), the toner particle precursors were aggregated until the volume average particle diameter of the aggregates reached 8.0 μm (Cv value: 17.8). Dt/Dc was 1.18, and the average circularity of the toner particles was 0.921. Further, the thus obtained toner had a favorable surface state, but some toner particles had a true spherical shape.

### Example 2

Toner particles having a volume average particle diameter of 12.9 μm (Cv value: 21.5) were obtained in the same manner as in Example 1 except that after preparing the dispersion of the toner particle precursors having a volume average particle diameter of 6.5 μm (Cv value: 16.5), the toner particle precursors were aggregated until the volume average particle diameter of the aggregates reached 12.9 μm (Cv value: 21). Dt/Dc was 1.98, and the average circularity of the toner particles was 0.894. Further, the thus obtained toner had a favorable surface state.

### Example 3

Toner particles having a volume average particle diameter of 7.9 μm (Cv value: 18.3) were obtained in the same manner as in Example 1 except that after preparing the dispersion of the toner particle precursors having a volume average particle diameter of 6.5 μm (Cv value: 16.5), the toner particle precursors were aggregated until the volume average particle diameter of the aggregates reached 7.9 μm (Cv value: 18.2). Dt/Dc was 1.22, and the average circularity of the toner particles was 0.915. Further, the thus obtained toner had a favorable surface state.

### Example 4

A dispersion of toner particle precursors having a volume average particle diameter of 7.5 μm (Cv value: 17.1) was prepared in the same manner as in Example 1 except that the amount of the 30% ammonium sulfate solution functioning as an aggregating agent was changed to 27 parts by mass. Then, toner particles having a volume average particle diameter of 9.5 μm (Cv value: 18.9) were obtained in the same manner as in Example 1 except that the toner particle precursors were aggregated until the volume average particle diameter of the aggregates reached 9.5 μm (Cv value: 19). Dt/Dc was 1.27, and the average circularity of the toner particles was 0.911. Further, the thus obtained toner had a favorable surface state.

### Example 5

Toner particles having a volume average particle diameter of 12.5 μm (Cv value: 22.4) were obtained in the same manner as in Example 4 except that after preparing the dispersion of the toner particle precursors having a volume average particle diameter of 7.5 μm (Cv value: 17.1), the toner particle precursors were aggregated until the volume average particle diameter of the aggregates reached 12.4 μm (Cv value: 22). Dt/Dc was 1.25, and the average circularity of the toner particles was 0.895. Further, the thus obtained toner had a favorable surface state.

Each of the thus obtained toners was dried, and with respect to 100 parts by mass of the toner, 2 parts by mass of hydrophobic silica and 0.5 parts by mass of titanium oxide were attached as additives to the surfaces of the toner particles, and then, the resulting toner was evaluated for charge stability and cleaning property. The evaluation of each toner was performed as follows.

### Evaluation Method for Charge Stability

A ferrite carrier coated with a silicone resin and each toner to which the additives were attached were mixed so that the concentration of the toner was 8% by mass, whereby a developer was prepared. The thus prepared developer was placed in an MFP (e-Studio 356) manufactured by Toshiba Tec Corporation, and in a normal temperature and normal humidity environment, a text image was formed on 10000 sheets and output. A change in charge amount (−q/m) was measured at every 2000 sheets during the formation of the text image on 10000 sheets and evaluated. The measurement of the charge amount was performed using a powder charge amount measuring device TYPE TB-203 (manufactured by Kyocera, Inc.).

### Evaluation Method for Cleaning Property

After the evaluation for charge stability was completed, the number of cleaning failures on a photoconductive drum was counted.

### Overall Evaluation Results

Based on the evaluation results of the respective evaluation items (charge stability and cleaning property), the evaluation was performed according to the following criteria.

A: The case where the charge retention is 95% or more and the number of cleaning failures is 0.

B: The case where the charge retention is 80% or more except for the above case rated “A” and the number of cleaning failures is less than 5.

C: The case except for the above case rated “A” or “B”.

The obtained results are shown in Table 1.

TABLE 1

| | | | | | The number of sheets with an image formed thereon and | | | | | | | Cleaning | |
|---|---|---|---|---|---|---|---|---|---|---|---|---|---|
| | | Physical properties of | | | charge amount (−q/m) | | | | | | | property | Overall |
| | | toner | | | 0 | 2000 | 4000 | 6000 | 8000 | 10000 | Charge | Number of | evaluation |
| | Dc | Dt | Dt/Dc | Circularity | sheets | sheets | sheets | sheets | sheets | sheets | retention | failures | result |
| Example 1 | 6.5 | 11.2 | 1.72 | 0.908 | 38 | 36 | 36 | 37 | 37 | 37 | 97% | 0 | A |
| Comparative | 6.5 | 6.6 | 1.02 | 0.964 | 42 | 44 | 43 | 42 | 43 | 42 | 100% | 11 | C |
| Example 1 | | | | | | | | | | | | | |
| Comparative | 6.5 | 7.7 | 1.18 | 0.921 | 39 | 39 | 41 | 40 | 39 | 39 | 100% | 7 | C |
| Example 2 | | | | | | | | | | | | | |
| Example 2 | 6.5 | 12.9 | 1.98 | 0.894 | 38 | 37 | 38 | 38 | 37 | 37 | 97% | 0 | A |
| Example 3 | 6.5 | 7.9 | 1.22 | 0.915 | 40 | 40 | 40 | 41 | 41 | 41 | 103% | 0 | A |
| Example 4 | 7.5 | 9.5 | 1.27 | 0.911 | 39 | 40 | 40 | 39 | 38 | 38 | 97% | 0 | A |
| Example 5 | 7.5 | 12.5 | 1.67 | 0.895 | 37 | 37 | 36 | 37 | 36 | 36 | 97% | 0 | A |

As shown in Table 1, the toners of the respective Examples falling within the scope of the present embodiment had favorable charge stability and cleaning property. On the other hand, the toners of Comparative Examples 1 and 2, which do not satisfy the formula (1) had a poor cleaning property.

While certain embodiments have been described, these embodiments have been presented by way of example only, and are not intended to limit the scope of the inventions. Indeed, the novel toner and method described herein may be embodied in a variety of other forms; furthermore, various omissions, substitutions and changes in the form of the toners and methods described herein may be made without departing from the spirit of the inventions. The accompanying claims and their equivalents are intended to cover such forms or modifications as would fall within the scope and spirit of the inventions.

As described in detail above, according to the technique described in this specification, a technique capable of improving the cleaning property and the charge stability of the toner can be provided.

What is claimed is:

1. A decolorizable toner, comprising toner particles including a binder resin and colorant particles which contain a color developable compound, a color developing agent, and a decolorizing agent, and have a capsule structure coated with an outer shell, wherein when the average circularity of the toner particles is represented by Rt, Rt satisfies the following formula (1): 0.85≦Rt≦0.92 (1).

2. The toner according to claim 1, wherein the colorant particles have a volume average particle diameter of 0.5 to 7 μm.

3. The toner according to claim 1, wherein the binder resin is contained in an amount of 60 to 80% by mass with respect to the total amount of the toner components.

4. The toner according to claim 1, wherein the colorant particles are contained in an amount of 10% by mass or more with respect to the total amount of the toner components.

5. A toner cartridge, comprising the toner according to claim 1.

6. An image forming apparatus, wherein an image is formed using the toner according to claim 1.

7. A method for producing a toner, comprising:
forming aggregates containing colorant particles;
aggregating binder resin particles and the obtained aggregates containing the colorant particles, thereby forming toner particle precursors; and
aggregating and fusing the obtained toner particle precursors, thereby forming toner particles, wherein
the average circularity of the toner particles is controlled so as to satisfy the following formula (1): 0.85≦Rt≦0.92 (1), wherein Rt represents the average circularity of the toner particles.

8. The method according to claim 7, further comprising aggregating the colorant particles and release agent particles, thereby forming aggregates containing the colorant particles and the release agent particles.

9. The method according to claim 7, wherein the volume average particle diameter of the toner particles and the volume average particle diameter of the toner particle precursors are controlled so as to satisfy the following formula (2): 1.2≦Dt/Dc≦2 (2), wherein Dt represents the volume average particle diameter (μm) of the toner particles and Dc represents the volume average particle diameter (μm) of the toner particle precursors.

10. The method according to claim 7, wherein the toner particle precursors are aggregated by at least any of the following methods: a method of decreasing the stirring speed of a dispersion containing the toner particle precursors as compared with the case where the toner particle precursors are formed; a method of increasing the temperature of the dispersion containing the toner particle precursors as compared with the case where the toner particle precursors are formed; and a method of adding an aggregating agent to the dispersion containing the toner particle precursors.

11. The method according to claim 7, wherein the colorant particles contain a color developable compound, a color developing agent, and a decolorizing agent, and have a capsule structure coated with an outer shell.

12. The method according to claim 7, wherein the colorant particles have a volume average particle diameter of 0.5 to 7 μm.

13. The method according to claim 7, wherein the colorant particles have a volume average particle diameter of 1 to 3 μm.

14. The method according to claim 7, wherein the binder resin particles have a volume average particle diameter of 0.1 to 0.5 μm.

15. The method according to claim 7, wherein the toner particle precursors have a volume average particle diameter of 6.5 to 7.5 μm.

16. The method according to claim 7, wherein the toner particles have a volume average particle diameter of 9.5 to 12.5 μm.
